(19) United States
(12) Patent Application Publication
(10) Pub. No.: US 2005/0198315 A1
(43) Pub. Date: Sep. 8, 2005

(54) Techniques for modifying the behavior of documents delivered over a computer network

(76) Inventors: Christopher W. Wesley, Redwood City, CA (US); Mark E. Pennell, Austin, TX (US); Kris Manian, Fremont, CA (US); Eric McKinlay, Cupertino, CA (US)

Correspondence Address: OKAMOTO & BENEDICTO, LLP, P.O. BOX 641330, SAN JOSE, CA, 95164, US

(21) Appl. No.: 10/778,374

(22) Filed: Feb. 13, 2004

(51) Int. Cl. G06F 15/16

(52) U.S. Cl. 709/228

(57) ABSTRACT

In one embodiment, a web page stored in a first server computer includes a reference to a wrapping code stored in a second server computer. The wrapping code may be pulled into a client computer when the page is downloaded to the client computer. Upon execution in the client computer, the wrapping code may add a functionality to the web page. The functionality added by the wrapping code may be activated along with a pre-existing functionality of the web page in response to a user interaction with the web page.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

The present invention relates generally to computer systems, and more particularly but not exclusively to the processing of documents received over a computer network.

2. Description of the Background Art

Large computer networks, such as the Internet, allow for relatively widespread and fast dissemination of information. On the Internet, for example, websites providing online services or information on various topics are readily accessible. A user having a computer and a web browser may navigate to one or more websites to access news, maps, computer programs, video, music, products, e-mail, and so on.

Websites typically run on one or more server computers that store downloadable documents referred to as “web pages.” As is well known, a web page may comprise textual and graphical data, as well as computer-readable program code to be executed in the client computer. A web page may also include advertisements for various products. Advertisements have the same role on the Internet as in radio and television. Generally speaking, advertisements generate revenue that allows a website to provide free or low cost access to information or service. For example, advertisements allow some websites to offer free e-mail service or access to the latest news.

A website may form a partnership with another website or another party providing products (i.e., goods or services) on the Internet. For example, websites may cooperatively display links to one another. As another example, a website may agree to display advertisements for another party, such as an online marketing company. Although these partnerships are generally good for a website, performing actions for other parties may require changes to existing web pages. A website may be hesitant to enter into a partnership that would entail significant changes to its web pages.

### SUMMARY

In one embodiment, a web page stored in a first server computer includes a reference to a wrapping code stored in a second server computer. The wrapping code may be pulled into a client computer when the page is downloaded to the client computer. Upon execution in the client computer, the wrapping code may add a functionality to the web page. The functionality added by the wrapping code may be activated along with a pre-existing functionality of the web page in response to a user interaction with the web page.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of a computer network in accordance with an embodiment of the present invention.

FIG. 2 pictorially illustrates how a wrapping code from a partner server computer may be received in a client computer in accordance with an embodiment of the present invention.

FIG. 3 shows a schematic diagram of an example computer that may be used in embodiments of the present invention.

FIG. 4 pictorially illustrates an example of a web page behavior after execution of a wrapping code in accordance with an embodiment of the present invention.

FIG. 5 pictorially illustrates the operation of a wrapping code in accordance with an embodiment of the present invention.

FIG. 6 shows a flow diagram of a method of modifying the behavior of a document received over a computer network in accordance with an embodiment of the present invention.

The use of the same reference label in different drawings indicates the same or like components.

### DETAILED DESCRIPTION

In the present disclosure, numerous specific details are provided, such as examples of systems, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

Being computer-related, it can be appreciated that the components disclosed herein may be implemented in hardware, software, or a combination of hardware and software (e.g., firmware). Software components may be in the form of computer-readable program code stored in a computer-readable storage medium, such as memory, mass storage device, or removable storage device. For example, a computer-readable storage medium may comprise computer-readable program code for performing the function of a particular component. Likewise, computer memory may be configured to include one or more components, which may then be executed by a processor. Components may be implemented separately in multiple modules or together in a single module.

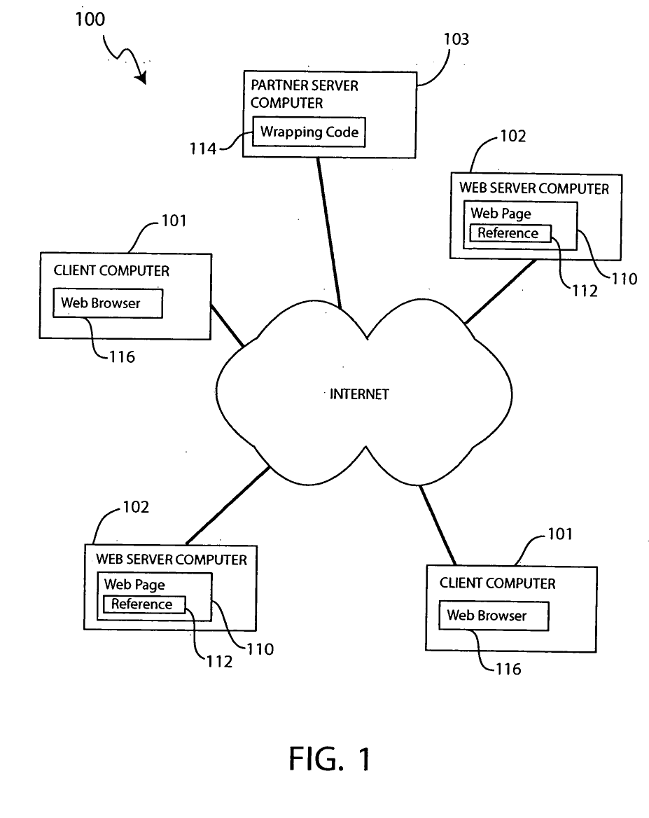

Referring now to FIG. 1, there is shown a schematic diagram of a computer network 100 in accordance with an embodiment of the present invention. Network 100 includes one or more client computers 101, one or more web server computers 102, one or more partner server computers 103, and other computers not shown. It is to be noted that the term “computer” includes any type of information processing device including personal digital assistants, digital telephones, wireless terminals, etc. Intermediate nodes such as gateways, routers, bridges, Internet service provider networks, public-switched telephone networks, proxy servers, firewalls, etc. are not shown for clarity. In the example of FIG. 1, network 100 includes the Internet; however, any type of computer network may also be used. Computers may be coupled to network 100 using any type of connection without detracting from the merits of the present invention.

A client computer 101 is typically, but not necessarily, a personal computer such as those running the Microsoft Windows™ operating system. A user employs a suitably equipped client computer 101 to get on network 100 and access computers coupled thereto. For example, a user on a client computer 101 may employ a web browser 116 to access web pages on a web server computer 102. A web browser 116 may be a commercially available web browser. In one embodiment, web browser 116 comprises the Microsoft Internet Explorer™ web browser.

A web server computer 102 may be a website containing information designed to attract users surfing on the Internet. A web server computer 102 includes one or more web pages 110 containing various types of information. A web page 110 may also include advertisements, links to other web pages, products available for online purchase, and so on. As is well known, a web page 110 may comprise viewable and non-viewable portions. The viewable portions of a web page 110 are those that are displayed on the screen of a client computer 101. The viewable portions of a web page 110 may include pictures, animations, texts, displayed links, buttons, entry fields, graphics, white space, background, and the like. The non-viewable portions of a web page 110 are those that are not displayed on a screen but are nonetheless downloaded to a client computer 101. Examples of non-viewable portions of a web page 110 include computer-readable program code (e.g., scripts, code to display viewable portions) and comments. In one embodiment, a web page 110 includes a reference 112. A reference 112 may comprise computer-readable program code pointed to a wrapping code 114 of a partner server computer 103. A reference 112 pulls a wrapping code 114 from a partner server computer 103 into a client computer 101 when a web page 110 is received in the client computer 101.

A partner server computer 103 may be a server computer or another website on a web server computer 102. In one embodiment, a partner server computer 103 is in partnership with a web server computer 102. Note that the partnership may involve a contractual agreement between the entities (e.g., individuals or companies) operating the partner server computer and the web server computer. Thus, any reference to a partnership between computers or websites should be understood as a partnership between the entities operating the computers or websites. In one embodiment, a partner server computer 103 includes a wrapping code 114, which may comprise computer-readable program code for modifying the behavior of a web page 110. When executed, a wrapping code 114 “wraps” a layer of functionality over a web page 110. As will be more apparent below, a wrapping code 114 allows activation of additional functionality not present in a web page 110 in a web server computer 102. For example, a wrapping code 114 may be configured to display an advertisement in a separate browser window, such as in a so-called pop-up browser window. The advertisement may be a coupon, special offer, an invitation to download software, information about a product (i.e., goods or services) or other websites, and so on. This functionality (displaying of a pop-up browser window) does not have to be present in a web page 110 as stored in a web server computer 102. The wrapping code 114 may add this functionality to the web page 110 after the web page 110 is received in a client computer 101.

The partnership between a web server computer 102 and a partner server computer 103 may involve the web server computer 102 performing some actions for the partner server computer 103. The partnership may entail allowing the partner server computer to display a pop-up or pop-under window to users accessing the web server computer 102. To make it relatively simple for the web server computer 102, a wrapping code 114 modifies the behavior of a web page 110 after the web page 110 is received in a client computer 101. A web page 110 as stored in the web server computer 102 may only require the addition of a reference 112 (which may be a single line of code) to be able to perform actions pursuant to the partnership. The reference 112 pulls the wrapping code 114 into the client computer 101 where the wrapping code is executed. Thus, a partner server computer 103 may contract with several web server computers 102 to run a wrapping code 114. The web server computers 102 may include a reference 112 to their web pages 110 to pull the same wrapping code 114 into client computers 101. As can be appreciated, this simplifies the maintenance and integration of a wrapping code 114.

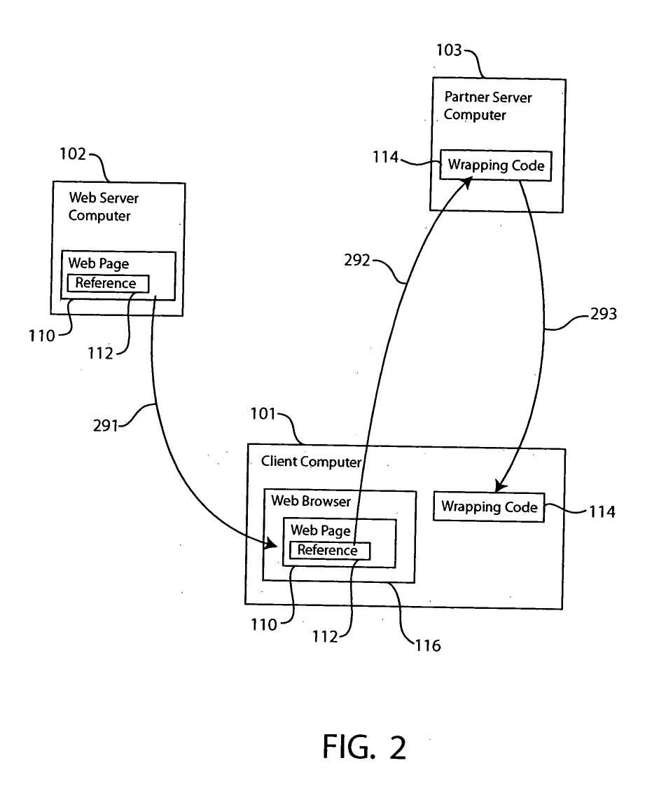

FIG. 2 pictorially illustrates how a wrapping code 114 from a partner server computer 103 may be received in a client computer 101 in accordance with an embodiment of the present invention. A user employing client computer 101 to surf the Internet may point web browser 116 to web page 110 of web server computer 102. This results in web page 110 being downloaded to client computer 101 (see arrow 291). Web browser 116 displays the viewable portions of web page 110 on the screen of client computer 101. Web browser 116 also allows for execution of computer-readable program code (e.g., HTML code, scripts) of web page 110, which includes reference 112. As mentioned, reference 112 may point to wrapping code 114 (see arrow 292). An example reference 112 may be:

<script language=“JavaScript”
src=“http://webpdp.gator.com/0/placement/000/”></script>

In the above example, “http://webpdp.gator.com/0/placement/000/” specifies the storage location of the wrapping code 114 on the Internet. When reference 112 is executed in client computer 101, wrapping code 114 is thus pulled from partner server computer 103 to client computer 101 (see arrow 293).

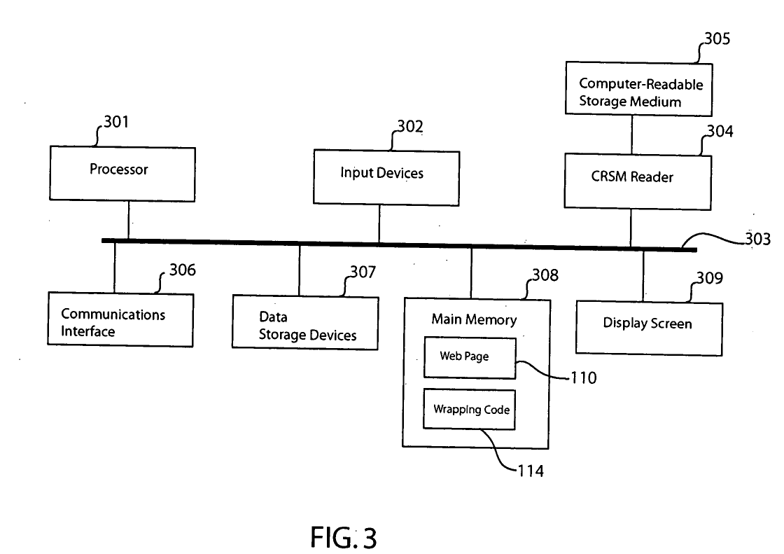

Turning now to FIG. 3, there is shown a schematic diagram of an example computer that may be used in embodiments of the present invention. Depending on its configuration, the computer shown in the example of FIG. 3 may be employed as a client computer or a server computer. In one embodiment, the computer of FIG. 3 is employed as a client computer 101. The computer of FIG. 3 may have less or more components to meet the needs of a particular application. As shown in FIG. 3, the computer may include a processor 301, such as those from the Intel Corporation or Advanced Micro Devices, for example. The computer may have one or more buses 303 coupling its various components. The computer may include one or more input devices 302 (e.g., keyboard, mouse), a computer-readable storage medium (CRSM) 305 (e.g., floppy disk, CD-ROM), a CRSM reader 304 (e.g., floppy drive, CD-ROM drive), a display screen 309 (e.g., cathode ray tube, flat panel display), a communications interface 306 (e.g., network adapter, modem) for coupling to a network, one or more data storage devices 307 (e.g., hard disk drive, optical drive, FLASH memory), and a main memory 308 (e.g., RAM). Software embodiments may be stored in a computer-readable storage medium 305 for reading into a data storage device 307 or main memory 308. In the example of FIG. 3, main memory 308 is configured to include components of a web page 110 and a wrapping code 114.

In one embodiment, wrapping code 114 modifies the behavior of a web page such that when a user interacts with the web page (e.g., by using her mouse to click on a portion of the web page), a new functionality added by the wrapping code is activated along with a pre-existing functionality of the web page. The new functionality added by wrapping code 114 may be the displaying of an advertisement, playing of a streaming audio, opening a new browser window for another web page, downloading files to the client computer, running another program in the client computer, and so on. The pre-existing functionality of the web page may be linking to another web page, opening another window, displaying an advertisement, and other functions capable of being performed by a web page.

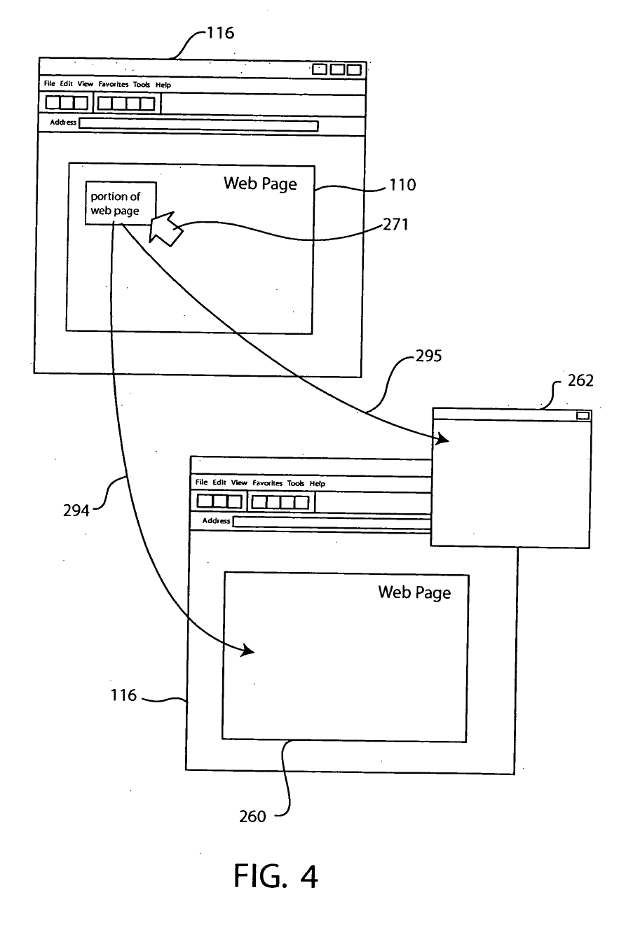

FIG. 4 pictorially illustrates an example of a web page behavior after execution of a wrapping code 114 in accordance with an embodiment of the present invention. In the example of FIG. 4, the functionality added by the wrapping code 114 to the web page 110 is the displaying of a separate browser window 262, while the pre-existing functionality of the web page 110 is the linking of web browser 116 to a web page 260. The web page 110, as stored in the web server computer 102, did not have the functionality of displaying a separate browser window 262. That is, the capability to display a separate browser window 262 is not in the web page 110 before execution of the wrapping code 114 in the client computer 101.

Still referring to FIG. 4, the user may place a mouse cursor 271 and click on a viewable portion of the web page 110. This results in the pre-existing functionality of the web page 110 to be activated, which in this particular example links the web browser 116 to a new web page 260 (see arrow 294). In response to the mouse click, the new functionality added by the wrapping code 114 is also activated, which in this particular example opens a separate browser window 262 (see arrow 295). In one embodiment, the separate browser window 262 displays an advertisement. Timing the displaying of browser window 262 with a user interaction, such as a mouse click on the web page 110, advantageously indicates to other programs that browser window 262 is displayed as part of a user interaction with the web page 110. This prevents so-called “pop-up blockers” from blocking browser window 262, and is thus especially important in situations where the displaying of an advertisement on browser window 262 helps pay for the development and maintenance of the web page 110. Without advertisements, such as those that may be displayed in a browser window 262, there may not be a web page 110 providing free information to users on the Internet.

In one embodiment, a wrapping code 114 is written in the JavaScript programming language. Other programming languages may also be used without detracting from the merits of the present invention.

In one embodiment, a wrapping code 114 locates all objects of a web page 110 and redefines the OnClick events of the objects to an event handler that performs the functionality added by the wrapping code. Put another way, the wrapping code 114 traps mouse clicks on the objects, and invokes an event handler in response. An example pseudo code for a wrapping code 114 in accordance with an embodiment of the present invention is shown in Table 1.

TABLE 1

wait for document to fully load;
for each document object {

object−>onClickMethod = newFunctionalityMethod;

}
newFunctionalityMethod( ){

open new pop-up browser window;

}

In the above example, the wrapping code 114 waits for the web page to fully load. The wrapping code 114 then looks for the objects that make up the web page 110. Clicking on any of the objects activates the new functionality added by the wrapping code 114, which opens a pop-up browser window that may contain an advertisement. In the example of Table 1, the pre-existing functionality of the web page 110 for the OnClick event is activated after the completion of newFunctionalityMethod. That is, any pre-existing functionality of the web page 110 normally executes after the newFunctionalityMethod. Note that functionalities other than the displaying of a pop-up browser window may also be added by the wrapping code 114. As is well known, a web page “object” may be a link, a white space, a text, a picture, etc. Appendix A shows an example JavaScript implementation of the pseudo code of Table 1.

In one embodiment, a wrapping code 114 locates all anchor objects of the web page 110 and redefines the OnClick events of the anchor objects to an event handler that performs the functionality added by the wrapping code. This technique is similar to that of Table 1, except limited to anchor objects rather than to objects in general. As is well known, an “anchor object” is a web page object that initiates navigation to another web page. An example of an anchor object is a link. Limiting the activation of the new functionality to anchor objects is advantageous in situations where the new functionality is only important in cases where the user would leave the web page for another web page. An example pseudo code for a wrapping code 114 that traps user interaction with an anchor object, in accordance with an embodiment of the present invention, is shown in Table 2.

TABLE 2
wait for document to fully load;
for each anchor object {

anchorObject−>onClickMethod = newFunctionalityMethod;

}
newFunctionalityMethod( ){

open new pop-up browser window;

}

The pseudo code of Table 2 is similar to that of Table 1 except for redefining the OnClick events of anchor objects rather than objects in general. Appendix B shows an example JavaScript implementation of the pseudo code of Table 2.

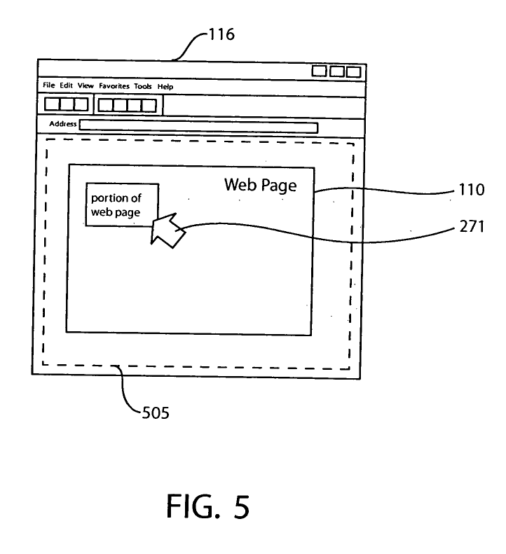

FIG. 5 pictorially illustrates the operation of a wrapping code 114 in accordance with an embodiment of the present invention. In the example of FIG. 5, the wrapping code 114 “overlays” a transparent layer 505 over the viewable portions of the web page 110. Note that the overlaying of the transparent layer 505 over the viewable portions of the web page 110 is done in memory. When a user interacts with the web page 110, the interaction is detected by the transparent layer 505. For example, when the user clicks on the web page 110, the click is actually made on the transparent layer 505, which is on top of the web page 110. The wrapping code 114 detects the coordinates of the transparent layer 505 that have been clicked on, activates a new functionality added by the wrapping code 114, and determines a viewable portion of the web page 110 having the same coordinates as the clicked portion of the transparent layer 505. The pre-existing functionality of the web page 110 for that viewable portion may then be activated by the wrapping code 114. For example, still referring to FIG. 5, if the portion of the web page 110 clicked on by the user is a link to another web page, web browser 116 will be forwarded to that other web page in addition to the activation of the new functionality added by the wrapping code 114. Table 3 shows an example pseudo code for a wrapping code 114 in accordance with an embodiment of the present invention.

TABLE 3

wait for document to fully load;
place transparent layer beneath mouse pointer, over viewable

page;

layer−>onClick = newFunctionalityMethod;
newFunctionalityMethod( ) {

open new pop-up browser window;
record click coordinates, x&y;
remove transparent layer;
locate object on viewable page at coordinates x&y;
located_object−>click( );

}

In the example of Table 3, the wrapping code 114 waits for the web page 110 to fully load. Thereafter, the wrapping code 114 places a transparent layer underneath a mouse cursor over the viewable portions of the web page 110. When the user clicks on the web page 110, the click is actually registered as being on the transparent layer. An event handler, which is assigned to monitor for mouse clicks on the transparent layer, activates the new functionality added by the wrapping code 114. The new functionality opens a separate browser window and records the coordinates of the affected portion (i.e. the portion clicked on by the user) of the transparent layer. The transparent layer is then removed. Thereafter, the object of the web page 110 at the recorded coordinates is clicked on to allow the pre-existing functionality assigned to that object, if any, to be activated. Appendix C shows an example JavaScript implementation of the pseudo code of Table 3.

Note that in the aforementioned embodiments, the user may click on a portion of the web page (e.g., a white space) having no corresponding pre-existing functionality. In that case, only the new functionality added by the wrapping code may be activated.

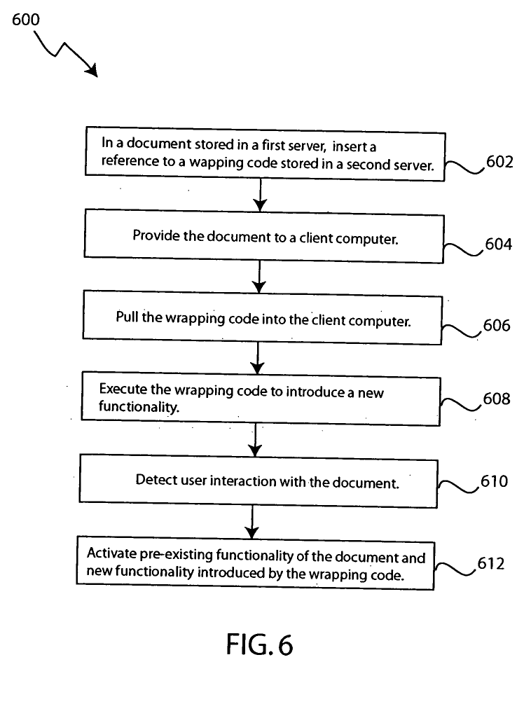

FIG. 6 shows a flow diagram of a method 600 of modifying the behavior of a document received over a computer network in accordance with an embodiment of the present invention. Method 600 may be implemented using the components shown in FIG. 1. However, other components may also be used without detracting from the merits of the present invention.

In step 602, a document stored in a first server computer includes a reference to a wrapping code stored in a second server computer. The document may be a web page, while the first and second server computers may be coupled over the Internet.

In step 604, the document is provided to a client computer coupled to the first and second server computers. For example, the first server computer may be a website providing web pages to client computers accessing the web site.

In step 606, the wrapping code is pulled from the second server computer to the client computer. The wrapping code may be pulled from the second server computer as a result of the reference being executed in the client computer.

In step 608, the wrapping code is executed to add a new functionality to the document. As can be appreciated, the wrapping code may also remove functionality from the document depending on the application. For example, the “new functionality” may be blocking or removal of pre-existing functionalities of the document. The “new functionality” may also be a modification to a pre-existing functionality. The new functionality may be the displaying of an advertisement in a separate browser window. For example, the advertisement may comprise an invitation to download an application program to the client computer. The advertisement may also comprise a coupon, special offer, information about a product (i.e., goods or services) or other websites, and so on.

In step 610, the wrapping code detects a user interaction with the document. The user interaction may be a mouse click on the document or a mouseover on the document, for example. Other user interactions are also possible without detracting from the merits of the present invention. The interaction with the document may be directly or indirectly, as is the case when a transparent layer is overlaid over the document.

In step 612, in response to the user interaction with the document, the wrapping code activates the new functionality and may also allow activation of a pre-existing functionality of the document.

Embodiments of the present invention provide advantages heretofore unrealized. Embodiments of the present invention advantageously allow a website to partner with another entity with minimum changes to its web pages. This facilitates formation of partnerships among providers on the Internet. Embodiments of the present invention allow new functionalities to be added to a web page after the web page has been received in a client computer.

While specific embodiments of the present invention have been provided, it is to be understood that these embodiments are for illustration purposes and not limiting. Many additional embodiments will be apparent to persons of ordinary skill in the art reading this disclosure.

APPENDIX A
Copyright 2004, Claria Corporation
var alreadyClicked=false, newWin, showUrl=“http://www.claria.com”;
function commenceClickWrap( inWin ){

if( inWin ){

inWin.location.replace( showUrl );
inWin.focus( );

}else{

clickWrap( );

}

}
function clickWrap( ){

if( document.readyState == ‘complete’ ){

redefineOnClicks( );

} else {

setTimeout( ‘commenceClickWrap( )’, 250 );

}

}
function showAdvertisement( ){

if( !alreadyClicked ){

alreadyClicked = true;
var newWin=window.open( “”, “newWin” );
if( newWin ){

newWin.location.replace( showUrl );
newWin.focus( );

}

}

}
function redefineOnClicks( ){

for( var i = 0; i < document.all.length; i++ ){

if( !document.all[i].onclick ){

document.all[i].onclick = showAdvertisement;

}

}

}
newWin = window.open( “”, “newWin” );
setTimeout( “commenceClickWrap( newWin )”, 250 );

APPENDIX B
Copyright 2004, Claria Corporation
var alreadyClicked=false, newWin, showUrl=“http://www.claria.com”;
function commenceLinkWrap( inWin ){

if( inWin ){

inWin.location.replace( showUrl );
inWin.focus( );

}else{

linkWrap( );

}

}
function linkWrap( ){

if( document.readyState == ‘complete’ ){

redefineOnClicks( );

} else {

setTimeout( ‘commenceLinkWrap( )’, 250 );

}

}
function showAdvertisement( ) {

if( !alreadyClicked ){

alreadyClicked = true;
var newWin=window.open( “”, “newWin” );
if( newWin ){

newWin.location.replace( showUrl );
newWin.focus( );

}

}

}
function redefineOnClicks( ){

for( var i = 0; i < document.links.length; i++ ){

if( !document.links[i].onclick ){

document.links[i].onclick = showAdvertisement;

}

}

}
newWin = window.open( “”, “newWin” );
setTimeout( “commenceLinkWrap( newWin )”, 250 );

APPENDIX C
Copyright 2004, Claria Corporation

var
newWin,origUnload=false,iLayer,winWidth=100,winHeight=100,posTop=
screen.availHeight/2-50,posLeft=screen.clientWidth/2-
50,push=“”,showUrl=“http://webpdp.gator.com/new-page.html”;
function pushWin(inWin){

try{

if(push==“up”){inWin.focus( );}else{inWin.blur( );}
inWin.moveTo(posLeft,posTop);inWin.location.replace(showUrl);

if(push==“up”){inWin.focus( );}else{inWin.blur( );window.focus( );}

}catch(e){}

}
function attachLayerHelper( ){

iLayer=document.createElement(“DIV”);

iLayer.style.visibility=“visible”;iLayer.style.width=7;iLayer.sty
le.height=7;iLayer.style.position=“absolute”;
iLayer.style.top=“0px”;iLayer.style.left=“0px”;iLayer.style.backg
roundColor=“red”;iLayer.style.backgroundImage=“URL(http://webpdp.
gator.com/pixel.gif)”;
iLayer.onclick=touchLayer;iLayer.id=“cLayer”;iLayer.innerHTML=“<i
mg height=‘1’/>”;attachLayer( );
}
function attachLayer( ){

if(document.readyState==‘complete’){

if(!origUnload){origUnload=window.onunload;window.onunload=unAtta
ch;}
try{document.body.insertBefore(iLayer,document.body.firstChild);i
Layer.style.zindex=1000;

}catch(e){setTimeout(“attachLayer( )”,250);}

}else{setTimeout(“attachLayer( )”,250);}
document.body.onmousemove=modPoint;
document.body.onscroll=modPoint;

}
function adjLayer(x,y){

iLayer.style.top=y−5;iLayer.style.left=x−5;

}
function modPoint( ){
adjLayer(window.event.clientX+document.body.scrollLeft,window.eve
nt.clientY+document.body.scrollTop);

var overNow=document.elementFromPoint(window.event.clientX-

6,window.event.clientY);

switch(overNow.nodeName){

| | |
|---|---|
| case | “A”: |

iLayer.style.cursor=“hand”;window.status=overNow.href;break;

| | |
|---|---|
| case | “INPUT”: |

if(overNow.type==“text”){iLayer.style.cursor=“text”;}break;

case “TEXTAREA”: iLayer.style.cursor=“text”;break;

default: iLayer.style.cursor=“auto”;window.status=“”;

}
if( document.getElementById(‘overWhat’) ){

document.getElementById(‘overWhat’).innerHTML =

overNow.nodeName + “ : ” + iLayer.style.cursor + “ : ” +
overWhat.previousSibling.tagName;

document.getElementById(‘overWhat’).style.position=“absolute”;

document.getElementById(‘overWhat’).style.top=window.event.client
Y+document.body.scrollTop+25;
document.getElementById(‘overWhat’).style.left=window.event.clien
tX+document.body.scrollLeft;

}

}
function unAttach( ){
if(document.getElementById(‘cLayer’)){document.body.removeChild(d
ocument.getElementById(‘cLayer’));}

if(origUnload){origUnload( )};

}
function touchLayer( ){

var

newWin=window.open(“”,“newWin”,“width=”+winWidth+“,height=”+winHe
ight+“,left=0,top=10000”);pushWin(newWin);

window.onunload=origUnload;origUnload=null;unAttach( );

document.elementFromPoint(window.event.clientX,window.event.clien
tY).click( );
}
function commence(inWin){

if(inWin){pushWin(inWin);
}else{attachLayerHelper( );}

}
newWin=window.open(“”,“newWin”,“width=”+winWidth+“,height=”+winHe
ight+“,left=0,top=10000”);
setTimeout(“commence(newWin)”,250);

1. A method of modifying a behavior of a web page, the method comprising:
storing a web page in a first server computer, the web page including a reference to a wrapping code stored in a second server computer;
providing the web page to a client computer;
pulling the wrapping code from the second server computer to the client computer;
executing the wrapping code in the client computer to add a functionality not present in the web page as stored in the first server computer; and
in response to a user interaction with the web page, activating a pre-existing functionality of the web page corresponding to the user interaction and activating the functionality added by the wrapping code.

2. The method of claim 1 wherein the pre-existing functionality of the web page includes pointing a web browser displaying the web page to another web page, and the functionality added by the wrapping code includes displaying an advertisement in a separate browser window.

3. The method of claim 1 wherein executing the wrapping code in the client computer comprises:
locating an object in the web page; and
configuring the client computer to activate the functionality added by the wrapping code whenever a user interacts with the object.

4. The method of claim 3 wherein configuring the client computer to activate the functionality added by the wrapping code comprises assigning to the object an event handler that displays an advertisement in a separate window whenever the user interacts with the object .

5. The method of claim 1 wherein the pre-existing functionality of the web page does not perform any action.

6. The method of claim 1 wherein executing the wrapping code in the client computer comprises positioning a transparent layer over a viewable portion of the web page.

7. The method of claim 6 wherein activating the pre-existing functionality of the web page comprises:
detecting a portion of the transparent layer affected by the user interaction with the web page;
determining a viewable portion of the web page that has a substantially same coordinates as the affected portion of the transparent layer; and
performing a pre-existing functionality assigned to the viewable portion of the web page.

8. The method of claim 7 wherein activating the functionality added by the wrapping code comprises displaying an advertisement in a separate browser window.

9. The method of claim 1 wherein the user interaction comprises a mouseover on an object of the web page.

10. The method of claim 1 wherein the user interaction comprises a mouse click on an object of the web page.

11. The method of claim 1 wherein the user interaction comprises a mouse click anywhere on the web page.

12. The method of claim 8 wherein the advertisement comprises an invitation to download an application program.

13. A system for modifying a behavior of a document provided over a computer network, the system comprising:
a first server computer including a document, the document including a reference and a pre-existing functionality; and
a second server computer including a wrapping code pointed to by the reference, the wrapping code being configured to be provided to and executed at a client computer upon downloading of the document to the client computer, the wrapping code including instructions to activate a functionality added by the wrapping code and to allow the pre-existing functionality to be activated in response to a user interaction with the document.

14. The system of claim 13 wherein the wrapping code comprises:
computer-readable program code for detecting the user interaction with the web page; and
computer-readable program code for displaying an advertisement in a separate browser window in response to the user interaction with the web page.

15. The system of claim 13 wherein the user interaction comprises a mouse click on any viewable portion of the web page.

16. The system of claim 13 wherein the wrapping code comprises:
computer-readable program code for locating an object in the web page;
computer-readable program code for displaying an advertisement in a separate browser window when a user interacts with the object; and
computer-readable program code for allowing a functionality assigned to the object to be activated, the functionality assigned to the object being pre-existing in the document as stored in the first server computer.

17. The system of claim 13 wherein the wrapping code comprises:
computer-readable program code for locating an anchor object in the web page;
computer-readable program code for displaying an advertisement in a separate browser window when a user interacts with the anchor object; and
computer-readable program code for allowing a functionality assigned to the object to be activated, the functionality assigned to the anchor object being pre-existing in the document as stored in the first server computer.

18. The system of claim 13 wherein the wrapping code comprises:
computer-readable program code for positioning a transparent layer over the document;
computer-readable program code for detecting a portion of the transparent layer affected by a user interaction with the document;
computer-readable program code for determining a viewable portion of the document that has a substantially same coordinates as the affected portion of the transparent layer; and
computer-readable program code for allowing a pre-existing functionality assigned to the viewable portion of the document to be activated.

19. A method of modifying a behavior of a web page receivable over an Internet, the method comprising:
providing a web page to a client computer over the Internet; the web page including a reference to a wrapping code stored in a server computer;
providing the wrapping code to the client computer;
displaying viewable portions of the web page in a web browser;
executing the wrapping code in the client computer to trap a mouse click on a viewable portion of the web page; and
in response to the mouse click on the viewable portion of the web page, displaying an advertisement in a separate browser window and displaying another web page on the web browser.

20. The method of claim 19 wherein executing the wrapping code in the client computer to trap the mouse click comprises:
locating an object in the web page; and
assigning an event handler to respond to a mouse click on the object, the event handler being added by the wrapping code.

21. The method of claim 20 wherein the event handler displays the advertisement in the separate browser window.

22. The method of claim 19 wherein executing the wrapping code in the client computer to trap the mouse click comprises:
positioning a transparent layer over the viewable portions of the web page.

23. The method of claim 19 wherein the advertisement comprises an invitation to download an application program.

24. A method of responding to a user interaction with a document, the method comprising:
providing a document to a client computer over a computer network; and
in response to a user interaction with the document, displaying a separate window and activating a pre-existing functionality of the document corresponding to the user interaction.

25. The method of claim 24 wherein the document comprises a web page and the computer network includes the Internet.

26. The method of claim 25 wherein the user interaction comprises a mouse click on a link on the web page.

27. The method of claim 24 wherein the document is not capable of displaying the separate window when the document is first received in the client computer.

28. The method of claim 27 wherein a wrapping code from a first server computer is pulled into and executed at the client computer to give the document the capability to display the separate window, the document being provided to the client computer by a second server computer.
